(19) United States
(12) Patent Application Publication
(10) Pub. No.: US 2024/0037558 A1
(43) Pub. Date: Feb. 1, 2024

(54) System For Digital Asset Transfer In A Digital Transaction And A Method Thereof

(71) Applicant: Pralhad Dinesh Deshpande, Singapore (US)

(72) Inventor: Pralhad Dinesh Deshpande, Singapore (US)

(73) Assignee: Half Epsilon Pte. Ltd., Singapore (SG)

(21) Appl. No.: 18/482,031

(22) Filed: Oct. 6, 2023

(30) Foreign Application Priority Data
Apr. 28, 2020 (SG) 10202003785S

(51) Int. Cl. G06Q 20/40; G06Q 20/38

(52) U.S. Cl. CPC G06Q 20/4014; G06Q 20/389

(57) ABSTRACT

The present invention discloses a system for transferring digital assets in a digital transaction and a method thereof. The method comprising the steps of providing user authentication information by a user by using an input module, authenticating the user authentication information by the input module, creating a request for either a new bearer digital asset or transferring an existing bearer digital asset, wherein a new digital asset is created by the input module and signed by the hardware module if the new bearer digital asset request is created, or a non-inclusion poof is generated for the existing bearer digital asset by the input module and signed by the hardware module along with the non-inclusion proof, creating a digital asset transfer message by the hardware module, updating a database of the input module; the database configured to maintain a digital asset balance information wherein the database is updated if the new bearer digital asset is created or the existing bearer digital asset is transferred, and sending a signed digital asset transfer message by the hardware module to the input module.

### FIELD OF THE INVENTION

The present invention generally relates to a system and a method for transferring digital assets in a digital transaction. More particularly, the present invention relates to a system and a method for transferring digital assets in a digital transaction in an asynchronous manner by using a trusted hardware module.

### BACKGROUND OF THE INVENTION

Conventionally, the central theme in digital asset transfer systems is double-spend prevention. There are three known ways to ensure that the same digital asset is not spent more than once. This results in three types of digital asset transfer systems which are described herein below.

Type 1: Centralized management of digital assets. Often, assets that may represent claims on some physical property, or securities that represent debt or investment in a common enterprise are captured in digital form as digital assets. The ownership of these assets can then change over a course of time as people transact with them, perhaps on digital asset exchanges. In this case, the centralized entity that manages the digital assets ensures that the same digital asset is not being transferred twice. However, this type of system has following disadvantages:
Centralized Governance: The central entity can unilaterally decide to allow or disallow any party to continue transacting in the system. They can also allow or disallow any transaction from completing.
Transactional Privacy: Such centralized systems do not offer transactional privacy to the transacting parties. The party that manages the digital assets if fully aware of who owns what and who transacted with whom.
Throughputs: While throughputs can be quite high, there's always a well-defined upper limit.
Fees: Usually, each transaction is charged a certain transaction fee.

Type 2: Decentralized management of digital assets. Crypto-currencies such as Bitcoin are an example of a digital asset that are managed by a decentralized system. Instead of a single entity being in charge of transaction processing, a group of entities are now in charge. Hence no single entity can prevent a transaction from going through. However, this type of system has following disadvantages:
Transactional Privacy: Usually, transaction privacy is even worse than that in type 1. While real identities of transacting parties may remain hidden, the transactions themselves are now publicly readable. This allows for transaction graph analysis and several times the exact transacting parties are identities by leveraging secondary sources of data.
Throughputs: Throughputs are generally very, very slow.
Fees: Usually, each transaction is charged a transaction fee. The fee changes over time based on how much demand there is to use the blockchain for performing digital asset transfers.

Type 3: DigiCash. The third type of digital asset transfer system simply focuses on double spend prevention and does not maintain information about users or the digital assets in their possession. Consequently, it is more privacy focused. Such a scheme was first presented by Chaum. In this scheme, a central entity maintains a list of unique serial numbers of spent coins. A payee that receives a coin can check that the coin they have received hasn't been spent previously. DigiCash was a functioning payment system based on Chaum's proposal. The DigiCash payment system was supported by Mark Twain Bank in the US and Deutsche Bank in Germany.
Throughputs: While throughputs can be quite high, there's always a well-defined upper limit.
Privacy: DigiCash protects payer's privacy but not that of the payee.
Fees: A fee maybe charged for each transaction.

Therefore, there exists a need for a digital asset transfer method and system that allows one party to transfer a digital asset to another over the Internet without any intermediaries mediating the transfer.

### SUMMARY OF THE INVENTION

Accordingly, in one aspect the invention provides a method for transferring digital asset in a digital transaction, the method comprising the steps of providing user authentication information by a user by using an input module, authenticating the user authentication information by the input module, creating a request for either a new bearer digital asset or transferring an existing bearer digital asset, wherein a new digital asset is created by the input module and signed by the hardware module if the new bearer digital asset request is created, or a non-inclusion poof is generated for the existing bearer digital asset by the input module and signed by the hardware module along with the non-inclusion proof, creating a digital asset transfer message by the hardware module, updating a database of the input module; the database configured to maintain a digital asset balance information wherein the database is updated if the new bearer digital asset is created or the existing bearer digital asset is transferred, and sending a signed digital asset transfer message by the hardware module to the input module.

In some embodiments, the method further comprising the steps of sending the signed digital asset transfer message to another user.

In some embodiments, the hardware module is adapted to either an input device of the user or to a remote server in communication with the input device.

In some embodiments, the input device is a personal computer, a laptop, a tablet or a mobile phone.

In some embodiments, the digital asset transfer message is a QR code or a text file.

In some embodiments, the hardware module generates a digital signature.

In some embodiments, the hardware module comprising a firmware, a crypto engine, an identity key (IK), a spent coins accumulator and a RAM.

In some embodiments, the spent coins accumulator is a cryptographic accumulator configured to validate proofs of set inclusion or non-inclusion.

In another embodiment, the present invention provides a method for carrying out an online transaction, comprising the steps of selecting an item to be purchased from the list of item available on a remote website, and performing method for transferring digital assets in a digital transaction in accordance with an embodiment of the present invention, wherein the online transaction is completed without prior registration of the user on the website.

In yet another aspect, the invention provides a system for transferring digital assets in a digital transaction, the system comprising, an input module configured to provide a user authentication information, a hardware module configured to authenticate the user authentication, the user requests a new bearer digital asset or transfers an existing bearer digital asset along with a non-inclusion proof on the input module, wherein the input module creates the new bearer digital asset which is signed by the hardware module if the new bearer digital asset request is created, or the input module generates a non-inclusion poof for the existing bearer digital asset which is signed by the hardware module along with the non-inclusion proof. The hardware module creates a digital asset transfer message. A is database configured to maintain a digital asset balance information, wherein the database is updated if the new bearer digital asset is created or the existing bearer digital asset is transferred. The hardware module sends a signed digital asset transfer message to the input module.

In some embodiments, the signed digital asset transfer message is further sent to another user.

In some embodiments, the hardware module is adapted to either an input device of the user or to a remote server in communication with the input device.

In some embodiments, the input device is a personal computer, a laptop, a tablet or a mobile phone.

In some embodiments, the digital asset transfer message is a QR code or a text file.

In some embodiments, the hardware module generates a digital signature.

In some embodiments, the hardware module comprising a firmware, a crypto engine, an identity key (IK), a spent coins accumulator and a RAM.

In some embodiments, the spent coins accumulator is a cryptographic accumulator configured to validate proofs of set inclusion or non-inclusion.

### BRIEF DESCRIPTION OF THE DRAWINGS

Reference will be made to embodiments of the invention, examples of which may be illustrated in accompanying figures. These figures are intended to be illustrative, not limiting. Although the invention is generally described in context of these embodiments, it should be understood that it is not intended to limit the scope of the invention to these particular embodiments.

FIG. 1 shows a system for transferring digital assets in a digital transaction in accordance with an embodiment of the present invention.

FIG. 2 shows a schematic diagram of interaction between a client and a server for the delivery of ad-free content of system of FIG. 1 in accordance with an embodiment of the present invention.

FIG. 3 shows a schematic diagram of interaction between a client and a server for the delivery of ad-free content of system of FIG. 1 in accordance with an embodiment of the present invention.

FIG. 4 shows a schematic diagram of protocol for purchasing content over internet using the system of FIG. 1 in accordance with an embodiment of the present invention.

### DETAILED DESCRIPTION OF THE INVENTION

The present invention is directed towards a system for transferring digital assets in a digital transaction and a method thereof by using a trusted hardware.

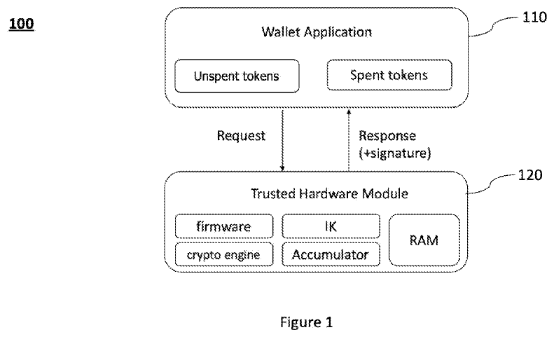

FIG. 1 shows a system (100) for transferring digital assets in a digital transaction. The system comprising an input module (110) and a hardware module (120).

In an embodiment, a user provides a user authentication information by using the input module implemented on an input device. The input device can be a personal computer, a laptop, a tablet or a mobile phone or the like. The user authentication information can be a user name and a password. In an exemplary embodiment, the input module can be a wallet application installed on the input device. The input module can also comprise a database which stores digital bearer digital asset information of the user. For instance, the database can store information in respect total number of digital bearer digital assets of the user, number of unspent digital assets, number of spent digital assets etc.

As shown, the hardware module is in communication with the input module. For instance, the hardware module can either be connected to the input device on which the input module is implemented or the hardware module can be connected to a remote server. The remote server is in communication with the input device on which the input module is implemented. In an embodiment, the hardware module comprising a firmware, a crypto engine, an identity key (IK), a spent coins accumulator and a RAM. In an exemplary embodiment, the spent coins accumulator is a cryptographic accumulator configured to validate proofs of set inclusion or non-inclusion.

In an embodiment, the firmware is permanent software programmed into a read-only memory which cannot be erased over-written. The code that validates the non-inclusion proof is stored in the firmware. If the validation is successful, the spent digital assets accumulator is modified. Cryptographic functions are securely executed inside the crypto-engine. It has various cryptographic algorithms. They are executed in a secure environment, i.e., their execution cannot be monitored by observers even with advanced tools. High level of security is in place to make sure that the cryptographic keys that are used in the algorithms are not compromised. The identity key is a public-private key pair. The private key is used to sign transactions. Further, there is a small amount of memory that securely stores the cryptographic accumulator. For instance, this is of size 32 bytes. Only the code that is burned into the firmware can change the value of the cryptographic accumulator.

Once the user is authenticated, the user can either request a new bearer digital asset to be created or transfer of an existing bearer digital asset. In case the user requests a new bearer digital asset to be created, the input module creates the new bearer digital asset. The new bearer digital asset is then signed by the hardware module. On the other hand, if the user requests a transfer of the existing bearer digital asset, the input module generates a non-inclusion proof for the existing digital asset which is signed by the hardware module.

[symbol] .

In an embodiment, if the new bearer digital asset is created or the existing bearer digital asset is transferred, hardware module creates a digital asset transfer message. For example, the digital asset transfer message can either be a text file or a QR code. The digital asset transfer can then be transferred over an email, a text message, or over whatsapp to another user or the like.

In an embodiment, the database is configured to maintain a digital asset balance information. The database is updated if the new bearer digital asset is created or the existing bearer digital asset is transferred and the information regarding total number unspent/spent digital assets is updated accordingly.

In an embodiment, the present invention also disclose a method for transferring digital assets in a digital transaction by using the system as described hereinabove.

In another embodiment, the present invention provides a method for carrying out an online transaction. The method comprising the steps of selecting an item to be purchased from the list of item available on a remote website, and performing method for transferring digital assets in a digital transaction as described hereinabove. Advantageously, by using the method for carrying out the online transaction in accordance with the present invention, the online transaction is completed without prior registration of the user on the website.

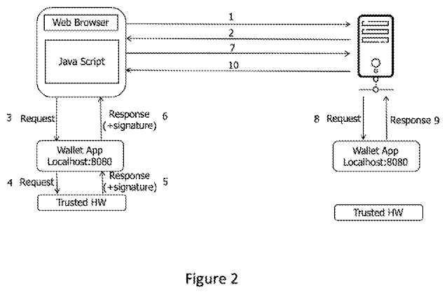

FIG. 2 shows a schematic diagram of interaction between a client and a server for the delivery of ad-free content of system of FIG. 1 in accordance with an embodiment of the present invention. The schematic diagram is an example of practical application of the system and method as described hereinabove.

Firstly, the user sends a web-request for a base URL. In response to the request, the webserver delivers a webpage containing links to various ad-free resources. When a link for an ad-free resource is clicked, this executes a JavaScript at the client. This JavaScript determines if a wallet application is running on the client input device and requests for a payment message to be extracted. The wallet application picks an unspent coin and invokes the trusted hardware module. The hardware module application responds with a signed payment message for the webserver. The wallet application relays the signed payment message to the JavaScript code executing in the client input device's browser. The browser sends a request to fetch the ad-free resource. The payment message is made part of the POST request. The webserver then invokes the local wallet application. The wallet application returns with a true if the payment message is valid and has not been received before and false otherwise. Accordingly, the webserver delivers the ad-free content.

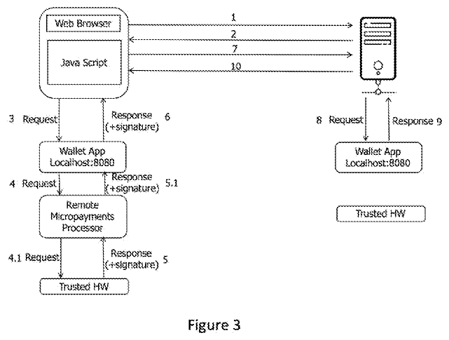

FIG. 3 shows another example of the practical application of the system and method as described hereinabove. The embodiment shown in FIG. 3 is similar to the embodiment as shown in FIG. 2. The only difference is that the trusted hardware connected to a remote server which is in communication with the input device. As shown, the wallet application running on the client input device interacts with a remote micro-payment processing system to generate a payment message. The remote system has a trusted hardware module. The user can maintain an account with this trusted third party that will be deducted from every time a micropayment is generated.

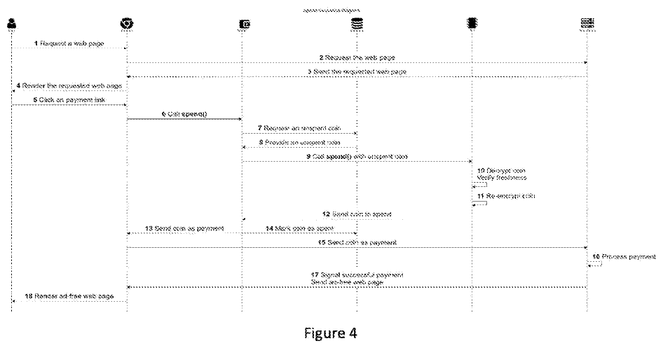

FIG. 4 shows a schematic diagram of protocol for purchasing content over internet using the system of FIG. 1 in accordance with an embodiment of the present invention. The protocol enables a user to purchase ad-free content as described in the preceding paragraphs with prior registration with the content provider.

Advantageously, the system and method of the present invention can be used to provide ad-free web browsing experience where consumers can freely navigate from one content distribution service to another, without vendor lock-in and while preserving their privacy without the fear of being continuously monitored.

In an exemplary embodiment, the present invention provides a method for providing digital content to a user. Firstly, the website server provides plurality of modes of displaying content to the user. The plurality of modes can be an ad-free mode, a non-targeted ads mode and a targeted ads mode. Thereafter, the digital content is displayed to the user based on the mode selected by the user. The digital transaction is then completed by performing the method of transferring digital assets in a digital transaction as described herein above. In an embodiment, the digital assets are transferred from the user to a digital content provider if the ad-free mode or non-targeted mode is selected by the user, and the digital assets are transferred from the digital content provider to user if the targeted ad mode is selected by the user. For instance, in ad free mode, no user data is collected and content is displayed without advertisements. This could be a charged mode. i.e., user pays a small amount, say $0.01 every time he clicks a web-link on that site. In non-targeted ads mode, no user data is collected and only nontargeted ads are displayed to the user. This could be offered without charge.

Further, when the system and method as described hereinabove is used for transferring digital assets, there will be no upper limit on the number of transactions that can be processed. The transfers will be private to the two parties. Furthermore, since there is no intermediary, there will not be any transaction processing fee. Therefore, very small valued payments can be processed. Even $0.0000001 can be transferred.

While the present invention has been described with respect to certain embodiments, it will be apparent to those skilled in the art that various changes and modification may be made without departing from the scope of the invention as defined in the following claims.

I/We claim:

1. A method for transferring digital assets in a digital transaction, the method comprising the steps of:
providing user authentication information by a user by using an input module (110);
authenticating the user authentication information by the input module;
creating a request for either a new bearer digital asset or transferring an existing bearer digital asset, wherein:
the new bearer digital asset is created by the input module and signed by a hardware module (120) if the new bearer digital asset request is created; or a non-inclusion poof is generated for the existing bearer digital asset by the input module (110) and signed by the hardware module along with the non-inclusion proof;
creating a digital asset transfer message by the hardware module;
updating a database of the input module (110); the database configured to maintain a digital asset balance information wherein the database is updated if the new bearer digital asset is created or the existing bearer digital asset is transferred; and
sending a signed digital asset transfer message by the hardware module to the input module (110).

2. The method for transferring digital assets in a digital transaction as claimed in claim 1, wherein the method further comprising the steps of sending the signed digital asset transfer message to another user.

3. The method for transferring digital assets in a digital transaction as claimed in claim 1, wherein the hardware module is adapted to either an input device of the user or to a remote server in communication with the input device.

4. The method for transferring digital assets in a digital transaction as claimed in claim 1, wherein the input device is a personal computer, a laptop, a tablet or a mobile phone.

5. The method for transferring digital assets in a digital transaction as claimed in claim 1, wherein the digital asset transfer message is a QR code or a text file.

6. The method for transferring digital assets in a digital transaction as claimed in claim 1, wherein the hardware module generates a digital signature.

7. The method for transferring digital asset in a digital transaction as claimed in claim 1, wherein the hardware module comprising a firmware, a crypto engine, an identity key (IK), a spent coins accumulator and a RAM.

8. The method for transferring digital asset in a digital transaction as claimed in claim 7, wherein the spent coins accumulator is a cryptographic accumulator configured to validate proofs of set inclusion or non-inclusion.

9. A method for carrying out an online transaction, comprising the steps of:
selecting an item to be purchased from the list of item available on a remote website; and
performing method for transferring digital assets in a digital transaction as claimed in claim 1;
wherein the online transaction is completed without prior registration of the user on the website.

10. A method for providing digital content to a user, the method comprising steps of:
providing plurality of modes of displaying content to the user, the plurality of modes including an ad-free mode, a non-targeted ads mode and a targeted ads mode; and
displaying digital content to the user based on the selected mode of displaying digital content; and
performing the method of transferring digital assets in a digital transaction as claimed in claim 1;
wherein the digital assets are transferred from the user to a digital content provider if the ad-free mode or non-targeted mode is selected by the user, and the digital assets are transferred from the digital content provider to user if the targeted ad mode is selected by the user.

11. A system for transferring digital assets in a digital transaction, the system comprising:
an input module (110) configured to provide a user authentication information; and
a hardware module configured to authenticate the user authentication information;
the user requests a new bearer digital asset or transfers an existing bearer digital asset along with a non-inclusion on the input module; wherein the input module (110) creates the new bearer digital asset which is signed by the hardware module if the new bearer digital asset request is created; or the input module generates a non-inclusion poof for the existing bearer digital asset which is signed by the hardware module along with the non-inclusion proof;
the hardware module creates a digital asset transfer message;
a database configured to maintain a digital asset balance information, wherein the database is updated if the new bearer digital asset is created or the existing bearer digital asset is transferred; and the hardware module sends a signed digital asset transfer message to the input module (110).

12. The system for transferring digital assets in a digital transaction as claimed in claim 11, wherein the signed digital asset transfer message is further sent to another user.

13. The system for transferring digital assets in a digital transaction as claimed in claim 11, wherein the hardware module (120) is adapted to either an input device of the user or to a remote server in communication with the input device.

14. The system for trasnferring digital assets in a digital transaction as claimed in claim 11, wherein the input device is a personal computer, a laptop, a tablet or a mobile phone.

15. The system for transferring digital assets in a digital transaction as claimed in claim 11, wherein the digital asset transfer message is a QR code.

16. The system for transferring digital assets in a digital transaction as claimed in claim 11, wherein the hardware module (120) generates a digital signature.

17. The system for transferring digital assets in a digital transaction as claimed in claim 11, wherein the hardware module (120) comprising a firmware, a crypto engine, an identity key (IK), a spent coins accumulator and a RAM.

18. The system for transferring digital assets in a digital transaction as claimed in claim 17, wherein the spent coins accumulator is a cryptographic accumulator configured to validate proofs of set inclusion or non-inclusion.
